(19) United States
(12) Patent Application Publication
(10) Pub. No.: US 2021/0058474 A1
(43) Pub. Date: Feb. 25, 2021

(54) METHOD AND SYSTEM TO TRANSMIT AUDIT/S OF A LOCK TO A MESSAGING APPLICATION

(71) Applicant: Carrier Corporation, Palm Beach Gardens, FL (US)

(72) Inventor: Sumanth Kumar Mukundala, Hyderabad (IN)

(21) Appl. No.: 16/989,453

(22) Filed: Aug. 10, 2020

(30) Foreign Application Priority Data
Aug. 22, 2019 (IN) 201911033901

(51) Int. Cl. H04L 29/08; G07C 9/00

(52) U.S. Cl. CPC H04L 67/22; G07C 9/00174

(57) ABSTRACT

Aspects of the invention are directed towards a system and a method for routing or transmitting one or more audit/s of a lock to a messaging application stored in an electronic device associated with a second user. One or more embodiments of the invention describe the method comprising steps of generating one or more audits by a lock being accessed by a first user and transmitting a request from the lock to a server for providing information associated with a messaging application of a second user. One or more embodiments of the invention further describe steps of receiving information associated with the messaging application of the second user from the server and transmitting the one or more audits to the messaging application of the second user.

### FOREIGN PRIORITY

This application claims priority to Indian Patent Application No. 201911033901, filed Aug. 22, 2019, and all the benefits accruing therefrom under 35 U.S.C. § 119, the contents of which in its entirety are herein incorporated by reference.

### TECHNICAL FIELD OF INVENTION

The present invention relates generally to electronic locking systems. More particularly, the invention relates to a system and a method to transmit audit/s of a lock to a messaging application.

### BACKGROUND OF THE INVENTION

At present, a lock may be accessed by a user by opening or closing the lock. Further, the lock may generate audits when the user opens or closes the lock. When these lock audits are generated by the lock, the lock may store the audits in a memory of the lock.

Currently, mechanisms exist for accessing lock audits from the memory of the lock. One such mechanism for accessing these lock audits from the memory of the lock is through a portable programmer (PP) or an extended portable programmer (XPP)—an advanced version of PP. The portable programmer needs to be connected to the lock and then the portable programmer retrieves the lock audits from the memory of the lock. Subsequently, the portable programmer may upload the lock audits to a server or may also transmit the lock audits to a front-desk system. Moreover, when the user of the lock wishes to access the lock audits, then this requires the user of the lock to approach the front-desk system for accessing the lock audits. This is a time-consuming and tedious task which may require manual intervention for accessing the lock audits from the lock. However, there is no mechanism or solution available to the user of the lock through which the user of the lock can directly access/receive the lock audits. Also, there is no mechanism or solution available through which the lock audits can be routed/transmitted to any other person when the lock is accessed by the user.

In view of the afore-mentioned problems in the existing mechanisms/solutions, there is a need of an efficient and effective system and a method for routing lock audits of the lock to the user. There is also a need for directly transmitting the lock audits to the user without any manual intervention. There is also a requirement for automatically routing the lock audits of the lock to any other person when the lock is accessed by the user. In order to solve the problems in the existing mechanisms/solutions, a system and a method are disclosed.

### SUMMARY OF THE INVENTION

Various embodiments of the invention describe a method for routing or transmitting lock audit/s to a messaging application of a user. The method comprises step of generating one or more audits by a lock, the lock being accessed by a first user. The method further comprises steps of transmitting a request from the lock to a server for providing information associated with a messaging application of a second user and receiving information associated with the messaging application of the second user from the server. Accordingly, the one or more audits are transmitted to the messaging application of the second user.

In an embodiment of the invention, the one or more audits are transmitted to the messaging application of the second user from the server through a network.

In another embodiment of the invention, the lock is associated with a premises or a locker or a key-box or a vehicle.

In yet another embodiment of the invention, the lock is accessed by the first user through an application operated on an electronic device associated with the first user or the lock is accessed manually.

In still another embodiment of the invention, the one or more audits are generated by the lock when the lock is opened or closed by the first user.

In another embodiment of the invention, the one or more audits are transmitted to the messaging application of the second user during a period of stay by the first user in a premises.

In yet another embodiment of the invention, the one or more audits are transmitted via a text message, an audio message, or an image message, related to an alert associated with the first user.

In still another embodiment of the invention, the information associated with the messaging application of the second user comprises an electronic mail address for the messaging application or a contact number for the messaging application of the second user.

In another embodiment of the invention, the information associated with the messaging application is provided by the first user or the second user to the server when the first user or the second user registers with the server.

In yet another different embodiment of the invention, the messaging application is stored in an electronic device associated with the second user. Also, the first user is related to the second user.

In a different embodiment of the invention, a system is disclosed for routing or transmitting lock audit/s to a messaging application of a user. The system comprises a lock and an electronic device. The lock comprises an audit generation unit configured to generate one or more audits associated with the lock, the lock being accessed by a first user and a communication unit configured to transmit a request from the lock to a server for providing information associated with a messaging application of a second user. The communication unit of the lock may also be configured to receive information associated with the messaging application of the second user from the server and transmit the one or more audits to the messaging application of the second user. Further, the electronic device is associated with the second user and comprises a memory coupled to a processor configured to store the messaging application. The electronic device also comprises a communication unit configured to receive the one or more audits from the lock and an interface configured to display the one or more audits in the messaging application of the second user.

In another embodiment of the invention, the lock is associated with a premises or a locker or a key-box or a vehicle.

In yet another embodiment of the invention, the lock is accessed by the first user through an application operated on an electronic device associated with the first user or the lock is accessed manually.

In still another embodiment of the invention, the one or more audits are generated by the lock when the lock is opened or closed by the first user.

In another embodiment of the invention, the one or more audits are transmitted to the messaging application of the second user during a period of stay by the first user in a premises.

In still another embodiment of the invention, the information associated with the messaging application of the second user comprises an electronic mail address for the messaging application or a contact number for the messaging application of the second user.

In another embodiment of the invention, the information associated with the messaging application is provided by the first user or the second user to the server when the first user or the second user registers with the server.

In yet another embodiment of the invention, the first user is related to the second user.

In another different embodiment of the invention, a computer readable medium is disclosed for routing or transmitting lock audit/s to a messaging application of a user. The computer readable medium comprising one or more processors and a memory coupled to the one or more processors, the memory storing instructions which are executed by the one or more processors. The one or more processors are configured to generate one or more audits by a lock being accessed by a first user and transmit a request from the lock to a server for providing information associated with a messaging application of a second user. The one or more processors are further configured to receive information associated with the messaging application of the second user from the server and transmit the one or more audits to the messaging application of the second user.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 depicts an exemplary system architecture according to an exemplary embodiment of the invention.

FIG. 2 depicts block diagram of different components in a lock according to an exemplary embodiment of the invention.

FIG. 3 depicts block diagram of different components in an electronic device according to an exemplary embodiment of the invention.

FIG. 4 depicts an exemplary flowchart illustrating a method to perform the invention according to an exemplary embodiment of the invention.

Corresponding reference numerals indicate corresponding parts throughout the drawings.

### DETAILED DESCRIPTION OF THE INVENTION

Described herein is the technology with a system and a method for routing or transmitting one or more audit/s of a lock to a messaging application stored in an electronic device associated with a second user. Further, the lock may generate the one or more audits when the lock is opened or closed by the first user.

As used herein, the lock may be a latching device and may be associated with a premises, a locker, a key-box or a vehicle. The lock may be connected with a server or with an electronic device associated with the second user through a network. Further, the lock may comprise, but is not limited to, an audit generation unit, a communication unit, a detector unit, a processor, and/or memory. Further, the lock may be accessed by the first user to open or close the lock. Moreover, the lock may be a smart lock, an electronic lock, an electro-mechanical lock, a mechanical lock or any such lock that is understood by a person skilled in the art. Also, the premises can be a room, a building or a floor where the lock can be installed.

As used herein, the one or more audits are associated with the lock. Also, the audits may be generated by the lock when a first user opens or closes the lock. The one or more audits may comprise details such as a day and a date on which the first user has accessed the lock, a time stamp indicating a time when the first user opens the lock, a time stamp indicating a time when the first user closes the lock, an information of the first user who is opening or closing the lock or any such detail that is obvious to a person skilled in the art. The one or more audits may be transmitted via a text message, an audio message, an image message or any such message related to an alert associated with the first user and including the details mentioned above.

As used herein, the first user may be a person who is using or accessing the lock. The first user may manually access the lock or may access the lock through an application accessed on an electronic device associated with the first user. Such application may be provided by a manufacturer/developer of the lock, a service-provider of a premises, an owner of a premises, a manufacturer/developer of the key-box, a manufacturer/developer of the vehicle or any other such application associated directly or indirectly with the lock. Various embodiments for such application have been described below in details.

As used herein, the second user may be a person who is not using or accessing the lock. Also, the second user may be related directly or indirectly to the first user. The second user may also be associated with an electronic device having a messaging application installed or stored therein. Various embodiments for such relation between the first user and the second user have been explained below in greater details.

As used herein, the messaging application may be stored in a memory of the electronic device associated with the second user. The messaging application may be an electronic-mail messaging application, an instant messaging application, a social network application or any such messaging application that is obvious to a person skilled in the art.

As used herein, the electronic device may be a desktop computer or a hand held device such as a mobile phone with a communication unit, an interface, a processor, a memory and/or with network connectivity. Examples of the electronic device include a desktop, a workstation PC, a laptop, a smart phone, a tablet, a wearable device and the like.

As used herein, the server has one or more processing capabilities and may also communicate with the lock or the electronic device through a network. Such server may be a cloud storage, a remote database, or any such storage known in the art.

As used herein, the network may refer to a Global System for Mobile (GSM) network, a room management network, Long-Term Evolution (LTE) network, a code-division multiple access (CDMA) network, a narrow-band internet of thing (NB-IoT) technique or category M1 technique, a bluetooth network, a WiFi network, a ZigBee network or any such network/technique that is known in the art.

Throughout the specification, reference numeral 110 depicts a single network. The reference numerals 110A, 110B, 110C . . . 110N may be considered as one or more networks.

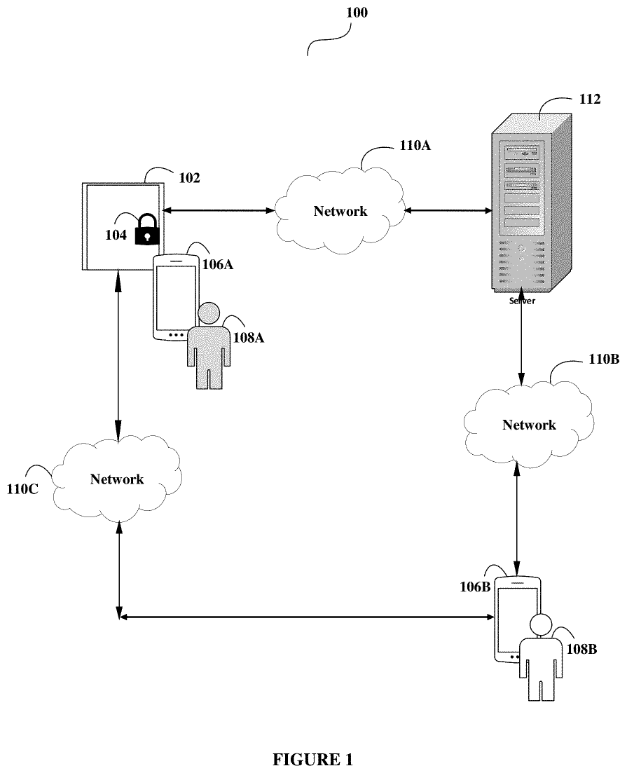

FIG. 1 depicts a system architecture 100 for routing or transmitting one or more audits of a lock to a messaging application, according to an exemplary embodiment of the invention. As depicted in FIG. 1, a lock 104 may be associated with a premises/locker/key-box/vehicle 102, a first electronic device 106A associated with a first user 108A, a server 112 connected with a network 110A/110B, a second electronic device 106B associated with a second user 108B, the second electronic device 106B connected with the network 110B/110C.

The first user 108A may access the lock 104 by opening or closing the lock 104. The first user 108A may access the lock 104 manually by using a Personal identification Number (PIN), a password, an access card or a key to access the lock 104. Alternatively, the first user 108A may access the lock 104 through an application stored in a memory of the first electronic device 106A. In a first exemplary embodiment, the application through which the first user 108A accesses the lock 104 may be provided by a hotel if the lock 104 is associated with a hotel. In a second exemplary embodiment, the application may be provided by a bank if the lock 104 is associated with a locker placed in the bank. In a third exemplary embodiment, the application may be provided by a vehicle manufacturer if the lock 104 is associated with a vehicle. In a fourth exemplary embodiment, the application may be provided by a key-box manufacturer if the lock 104 is associated with the key-box. Although, a limited number of exemplary scenarios for using the application have been described herein, however, it is understood for a person skilled in the art that any other scenario can also be applicable to demonstrate the usage of the application for accessing the lock 104.

Whenever the lock 104 is closed or opened by the first user 108A, the lock 104 may detect the closing or opening of the lock 104 and may then generate one or more audits at predetermined intervals or at a predetermined time. The one or more audits are associated with the lock 104 and may comprise details such as a day and a date on which the first user 108A has accessed the lock 104, a time stamp indicating a time when the first user 108A opens the lock 104, a time stamp indicating a time when the first user 108A closes the lock 104, an information of the first user 108A who is opening or closing the lock 104 or any such details that is obvious to a person skilled in the art. The one or more audits may also comprise a text message, an audio message, an image message or any such message related to details mentioned above.

Then, the lock 104 may transmit a request to the server 112 through the network 110A for providing information associated with a messaging application of the second user 108B. The lock 104 requests the server 112 for the information in order to transmit the one or more audits to the messaging application of the second user 108B. Such messaging application may be stored in the second electronic device 106B associated with the second user 108B. Further, the information associated with the messaging application of the second user 108B may comprise an electronic mail address for the messaging application or a contact number for the messaging application of the second user 108B, a name of the second user 108B or a relation details of the second user 108B with the first user 108A. Such information can be provided by the first user 108A or the second user 108B to the server 112 through the network 110A/110B at the time when the first user 108A or the second user 108B registers with the server 112 or any time before the first user 108A or the second user 108B accesses the lock 104. In a first exemplary embodiment, the first user 108A or the second user 108B may register with the server 112 while booking a room in a hotel. In a second exemplary embodiment, the first user 108A or the second user 108B may register with the server 112 after booking a locker in a bank. In a third exemplary embodiment, the first user 108A or the second user 108B may register with the server 112 after purchasing a vehicle. In a fourth exemplary embodiment, the first user 108A or the second user 108B may register with the server 112 after purchasing a key-box. In particular, the first user 108A or the second user 108B may provide the information to the server 112 through the application stored in their respective electronic devices 106A/106B. As discussed above, such application may be provided by a manufacturer/developer of the lock 104, a service-provider of a premises 102, an owner of a premises 102, a manufacturer/developer of the key-box 102, a manufacturer/developer of the vehicle 102 or by any such application associated directly or indirectly with the lock 104. As discussed herein, either the first user 108A or the second user 108B may register with the server 112. In one exemplary scenario, the first user 108A may register with the server 112 for using the room, the locker, the vehicle, or the key-box himself/herself and may provide the information associated with the messaging application of the second user 108B to the server 112 for transmitting the audits to the messaging application of the second user 108B. In other exemplary scenario, the second user 108B books the room, the locker, the vehicle, or the key-box for the first user 108A who finally uses the room, the locker, the vehicle, or the key-box. While booking for the first user 108A, the second user 108B may provide the information associated with the messaging application of the second user 108B to the server 112 for transmitting the audits to the messaging application of the second user 108B.

Once the server 112 receives the information from the first user 108A or the second user 108B through the network 110A/110B, the server 112 may store the information in a memory of the server 112. When the server 112 receives the request from the lock 104 through the network 110A for providing information, then the server 112 may determine the information associated with the messaging application of the second user 108B from the memory of the server 112 and may transmit the information associated with the messaging application to the lock through the network 110A. Then, the lock 104 may receive the information associated with the messaging application of the second user 108B from the server 112 through the network 110A.

After receiving the information associated with the messaging application of the second user 108B from the server 112, the lock 104 may transmit the one or more audits of the lock 104 through the network 110C to the messaging application stored in the second electronic device 106B. Specifically, the lock 104 may use the information (such as the contact number or the electronic mail address of the second user 108B) associated with the messaging application and accordingly, transmit the one or more audits to the messaging application of the second user 108B. In an alternative embodiment, the lock 104 may route the one or more audits of the lock 104 to the server 112 through the network 110A and in turn, the server 112 may transmit the one or more audits of the lock 104 to the messaging application of the second user 108B through the network 110B. The lock 104 may transmit the one or more audits to the messaging application of the second user 108B periodically or on occurrence of an event. In an embodiment, the lock may transmit the one or more audits every hour or once in a day. In another embodiment, the lock may transmit the one or more audits to the messaging application stored in the second electronic device 106B whenever the audits are generated by the lock 104. In an exemplary embodiment, the one or more audits are transmitted to the messaging application of the second user 108B during a period of stay by the first user 108A in a premises 102. After the expiration of the period of stay, the audits are not transmitted to the messaging application of the second user 108B. Although the present invention has been described with respect to the lock 104, the server 112 and the electronic device 106A/106B communicating with each other through the networks 110A/110B/110C as described above; however, it is understood for a person skilled in the art that these networks 110A/110B/110C can be same networks or can be different networks as well.

The present invention encompasses various exemplary embodiments to elucidate the relation between the first user 108A and the second user 108B. In a first exemplary embodiment, the first user 108A may be a child and the second user 108B may be a parent who wishes to receive the one or more audits of the lock 104 when the first user 108A (i.e. the child) access the lock 104. In a second exemplary embodiment, the first user 108A may be a team member/s and the second user 108B may be a coach, where the coach wishes to receives the one or more audits of the lock 104 when the first user 108A (i.e. team member) accesses the lock 104. In a third exemplary embodiment, the first user 108A may be an employee and the second user 108B may be a boss. In a fourth exemplary embodiment, the first user 108A may be a person (e.g. a thief) who tries to open the lock 104 of a car/vehicle and the second user 108B may be a car owner. In a fifth exemplary embodiment, the first user 108A may be a student who opens or closes the lock 104 of a classroom and the second user 108B may be a teacher. In a sixth exemplary embodiment, the first user 108A may be a person who tries to open the lock 104 of a locker placed in a bank and the second user 108B may be a person who is the holder of the locker. In a seventh exemplary embodiment, the first user 108A may be a person who tries to open the lock 104 of a key-holder (having keys inside) and the second user 108B may be a purchaser of the key-holder. Also, the first user 108A and the second user 108B may be friends where the audits of the lock are transmitted to the messaging application of the second user 108B. Although, a limited number of scenarios depicting exemplary relation between the first user 108A and the second user 108B have been described herein, however, it is understood for a person skilled in the art that any other scenario can be applicable to elucidate the relation between the first user 108A and the second user 108B.

The present invention facilitates the transmission of the one or more audits of the lock 104 to the messaging application of the second user 108B only when the first user 108A opts for transmitting the one or more audits to the second user 108B or when the second user 108B opts for receiving the one or more audits. Such option can be selected by the first user 108A or the second user 108B through the application while registering with the server 112 or any time before accessing the lock 104. While selecting the option, the first user 108A or the second user 108B may also provide the information associated with the messaging application of the second user 108B as discussed above. In case, the first user 108A or the second user 108B does not opt to transmit/receive the one or more audits, then the lock 104 does not transmit the one or more audits to the messaging application of the second user 108B.

The present invention further facilitates the lock 104 to receive videos/images of the first user 108A captured by at least one camera while the first user 108A accesses the lock 104. Such cameras may be installed in the premises/locker/key-box/vehicle 102 or at a place where the locker/key-box/vehicle 102 is situated. The lock 104 may analyze the captured videos/images to identify the first user 108A who is accessing the lock 104. Then, the lock 104 may transmit identification details, an image of the first user 108A along with the one or more audits of the first user 108A to the second user 108B through the server 112 or through the network 110C. Alternatively, the at least one camera may directly transmit the captured videos/images to the server 112 through a network. Then, the server 112 may identify the first user 108A who is accessing the lock 104 and transmit identification details (along with the one or more audits and the image of the first user 108A) of the first user 108A to the lock 104.

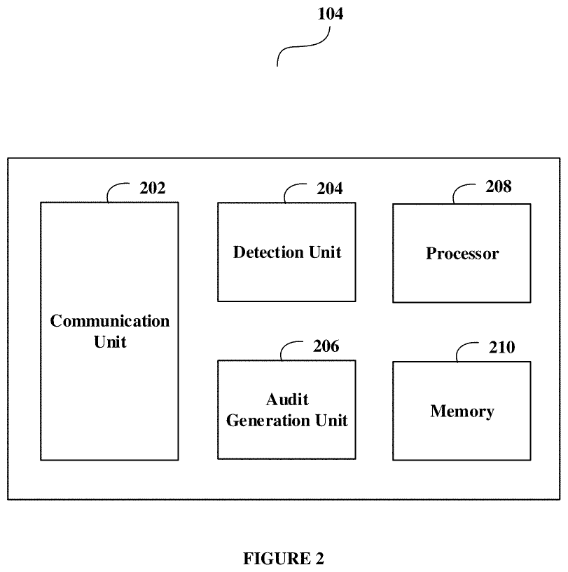

FIG. 2 depicts a block diagram of different components in a lock 104 according to an exemplary embodiment of the invention. The lock 104 may comprise of, but is not limited to, a communication unit 202, a detection unit 204, an audit generation unit 206, a processor 208 and a memory 210. The detection unit 204 may be configured to detect a closing or an opening of the lock 104 whenever the lock 104 is closed or opened by a first user 108A. The audit generation unit 206 may be configured to generate one or more audits when the detection unit 204 detects closing or opening of the lock 104. The audit generation unit 206 may be configured to provide the generated one or more audits of the lock 104 to the communication unit 202. Then, the communication unit 202 may be configured to communicate with a server 112 through a network 110A for providing information associated with a messaging application of a second user 108B. The communication unit 202 may also be configured to receive the information associated with the messaging application of the second user 108B from the server 112 through the network 110A. The communication unit 202 of the lock 104 may further be configured to transmit the one or more audits of the lock 104 through the network 110C to the messaging application stored in the second electronic device 106B, as discussed above. The memory 210 may be configured to store the one or more audits of the lock 104, an identifier of the lock 104, or the information associated with the messaging application of the second user 108B. The communication unit 202, the detection unit 204, the audit generation unit 206, and/or the memory 210 may be communicably coupled with the processor 208.

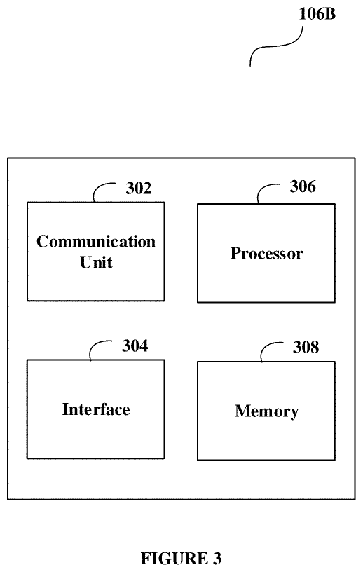

FIG. 3 depicts a block diagram of different components in a second electronic device 106B according to an exemplary embodiment of the invention. The second electronic device 106B may comprise, but is not limited to, a communication unit 302, an interface 304, a processor 306 and a memory 308. The communication unit 302 of the electronic device 106B may be in communication with the lock 104 through a network 110C and with a server 112 through a network 108B. In an embodiment, the communication unit 202 may be a short-range transceiver. In another embodiment, the communication unit 202 may be a cellular transceiver. Further, the communication unit 302 may be configured to receive the one or more audits from the lock 104 or the server 112. The interface 304 may be configured to display the one or more audits of the lock in the messaging application. The memory 308 may be configured to store the messaging application. The communication unit 302, the interface 304, and/or the memory 308 may be communicably coupled with the processor 306.

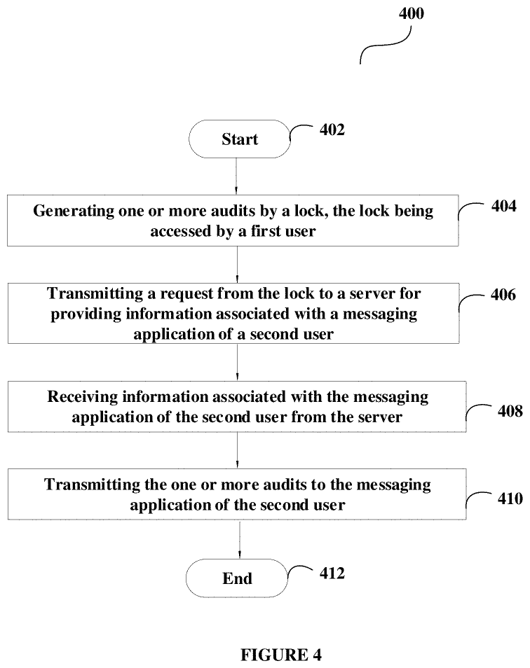

FIG. 4 depicts a flowchart outlining the features of the invention in an exemplary embodiment of the invention. The method flowchart 400 describes a method being performed for routing or transmitting one or more audits of a lock 104 to a messaging application. The method flowchart 400 starts at step 402.

At step 404, the lock 104 may be closed or opened by a first user 108A. Then, the lock 104 may detect the closing or opening of the lock 104 and may generate one or more audits after detecting the closing or opening of the lock 104.

At step 406, the lock 104 may transmit a request to the server 112 through the network 110A for providing information associated with a messaging application of a second user 108B. Such messaging application may be stored in the second electronic device 106B associated with the second user 108B.

At step 408, the lock 104 may receive the information associated with the messaging application of the second user 108B from the server 112 through the network 110A.

At step 410, the lock 104 may transmit the one or more audits of the lock 104 through the network 110C to the messaging application stored in the second electronic device 106B. In specific, the lock 104 may use the information (such as the contact number or the electronic mail address of the second user 108B) associated with the messaging application and accordingly, transmit the one or more audits to the messaging application of the second user 108B. The method flowchart may end at 412.

The present invention is applicable to various fields/industries such as, but not limited to, hospitality industry, real-estate industry, hostels, educational institutes, banking sector, automobile industry, and any such field/industry where the lock can be used and is obvious to a person skilled in the art.

The present invention provides the following technical advantages over the existing solutions a) automatically informing a second user about a first user by transmitting audits to the second user, b) provides tracking of user by routing the audits, c) transmits the audits to the second user without any manual intervention, and d) eliminates the need to approach front-desk systems for retrieving the audits, e) provides real-time updates to the second user about the first user, and prevents misuse of the lock by the first user.

The embodiments of the invention and the tables discussed herein are exemplary and various modification and alterations to a person skilled in the art are within the scope of the invention.

In one embodiment of the invention, the invention can be operated using the one or more computer readable devices. The one or more computer readable devices can be associated with the lock 104. A computer readable medium comprising one or more processors and a memory coupled to the one or more processors, the memory storing instructions which are executed by the one or more processors, the one or more processors configured to generate one or more audits by a lock 104 being accessed by a first user 108A and transmit a request from the lock 104 to a server 112 for providing information associated with a messaging application of a second user 108B. The memory storing instructions which are executed by the one or more processors, the one or more processors configured to receive information associated with the messaging application of the second user 108B from the server 112 and transmit the one or more audits to the messaging application of the second user 108B.

Exemplary computer readable media includes flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this invention are not signals per se. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, examples of the invention are capable of implementation with numerous other general purpose or special purpose computing system environments, configurations, or devices.

Examples of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the Figures/Tables and described herein. Other examples of the invention may include different computer-executable instructions or components having more or less functionality than illustrated and described herein.

Aspects of the invention transform a general-purpose computer into a special-purpose computing device when configured to execute the instructions described herein.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “data store,” “data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Furthermore, the terms “user,” “subscriber,” “customer,” “consumer,” “agent,” and the like are employed interchangeably throughout the subject specification, unless context warrants particular distinction(s) among the terms. Such terms can refer to human entities or automated components supported through artificial intelligence (e.g., a capacity to make inference based on complex mathematical formalisms) which can provide simulated vision, sound recognition and so forth.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C”.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
generating one or more audits by a lock, the lock being accessed by a first user;
transmitting a request from the lock to a server for providing information associated with a messaging application of a second user;
receiving information associated with the messaging application of the second user from the server; and
transmitting the one or more audits to the messaging application of the second user.

2. The method of claim 1, wherein the one or more audits are transmitted to the messaging application of the second user from the server through a network.

3. The method of claim 1, wherein the lock is associated with a premises or a locker or a key-box or a vehicle.

4. The method of claim 1, wherein the lock is accessed by the first user through an application operated on an electronic device associated with the first user or the lock is accessed manually.

5. The method of claim 1, wherein the one or more audits are generated by the lock when the lock is opened or closed by the first user.

6. The method of claim 1, wherein the one or more audits are transmitted to the messaging application of the second user during a period of stay by the first user in a premises.

7. The method of claim 1, wherein the one or more audits are transmitted via a text message, an audio message, or an image message related to an alert associated with the first user.

8. The method of claim 1, wherein the information associated with the messaging application of the second user comprises an electronic mail address for the messaging application or a contact number for the messaging application of the second user.

9. The method of claim 1, wherein the information associated with the messaging application is provided by the first user or the second user to the server when the first user or the second user registers with the server.

10. The method of claim 1, wherein the messaging application is stored in an electronic device associated with the second user.

11. The method of claim 1, wherein the first user is related to the second user.

12. A system comprising:
a lock comprising:
an audit generation unit configured to generate one or more audits associated with the lock, the lock being accessed by a first user; and
a communication unit configured to:
transmit a request from the lock to a server for providing information associated with a messaging application of a second user;
receive information associated with the messaging application of the second user from the server; and
transmit the one or more audits to the messaging application of the second user; and
an electronic device associated with the second user, the electronic device comprising:
a memory coupled to a processor configured to store the messaging application;
a communication unit configured to receive the one or more audits from the lock; and
an interface configured to display the one or more audits in the messaging application of the second user.

13. The system of claim 12, wherein the lock is associated with a premises or a locker or a key-box or a vehicle.

14. The system of claim 12, wherein the lock is accessed by the first user through an application operated on an electronic device associated with the first user or the lock is accessed manually.

15. The system of claim 12, wherein the one or more audits are generated by the lock when the lock is opened or closed by the first user.

16. The system of claim 12, wherein the one or more audits are transmitted to the messaging application of the second user during a period of stay by the first user in a premises.

17. The system of claim 12, wherein the information associated with the messaging application is provided by the first user or the second user to the server when the first user or the second user registers with the server.

18. The system of claim 12, wherein the information associated with the messaging application of the second user comprises an electronic mail address for the messaging application or a contact number for the messaging application of the second user.

19. The system of claim 12, wherein the first user is related to the second user.

20. A computer readable medium comprising one or more processors and a memory coupled to the one or more processors, the memory storing instructions executed by the one or more processors, the one or more processors configured to:
generate one or more audits by a lock, the lock being accessed by a first user;
transmit a request from the lock to a server for providing information associated with a messaging application of a second user;
receive information associated with the messaging application of the second user from the server; and
transmit the one or more audits to the messaging application of the second user.
